(19) United States
(12) Patent Application Publication
(10) Pub. No.: US 2022/0127905 A1
(43) Pub. Date: Apr. 28, 2022

(54) Side Guide for a Screen Device

(71) Applicant: Renson Sunprotection Screens NV, Waregem (BE)

(72) Inventors: Louis Jonas Cortvriendt, Oostende (BE); Maxim Gustave Solomaniuck, Gent (BE); Sofie Rumbaut, Gent (BE); Jonas Willem Maertens, Gent (BE); Steven Rita André Vanhoutte, Deerlijk (BE); John Peter Meinster, Gentbrugge (BE); Michiel Maurice Desplenter, Waregem (BE); Dirk Jennis, Roeselare (BE)

(21) Appl. No.: 17/428,923

(22) PCT Filed: Feb. 13, 2020
(86) PCT No.: PCT/IB2020/051166

§ 371 Date: Aug. 5, 2021

(30) Foreign Application Priority Data
Feb. 15, 2019 (BE) 2019/5100

(51) Int. Cl. E06B 9/58; E06B 9/42

(52) U.S. Cl. CPC E06B 9/581; E06B 2009/587; E06B 9/42

(57) ABSTRACT

The invention relates to the field of side guides for screen devices for reliable screens. The invention furthermore concerns methods for mounting and removing the side guide.

### TECHNICAL FIELD

The invention relates to the field of side guides for screen devices for rollable screens. The invention furthermore also concerns methods for mounting and removing the side guide.

### TECHNOLOGICAL BACKGROUND TO THE INVENTION

Rollable screens are typically used as sun blinds or roller shutters on windows or doors. To secure and protect the screen, this is typically placed in a screen device which for example can be attached to a wall or in a casing. For both in-built systems, surface-mounted systems and for top-mounted systems, access to the screen device is required in order to perform maintenance work, such as replacement of damaged components.

Traditionally, the components of such screen devices, such as components of the side guides of the screen, are attached to each other by means of fixing elements, such as nails and screws. Wind tunnel tests however reveal that the fixing elements form the weakest points. Under high wind loads, the pressure on the screen is typically absorbed by the profiles in which the screen is attached, but these profiles are connected together by fixing elements. The side guide for example is loaded to a maximum when the fabric is unrolled and the screen is exposed to wind loading.

Under excessive loads, the entire screen device may lose its functionality (in particular for absorbing wind loads) or components may even break away. A screen which has once been exposed to extreme wind loads may suffer detachment of fixing means, and consequently detachment of components. Also, the repeated screwing of the side guides in and out, or over-tight screwing in (wherein the screw can lose its effectiveness) may prevent the screw from fastening adequately, and breakages may occur.

In addition, the use of fixing elements also makes the mounting and removal of such screen devices more labour-intensive. Firstly, secondary tools such as screwdrivers are required to mount the device correctly. Subsequent removal may lead to permanent damage to the profiles or the screen if not performed carefully (for example, screwing in too hard). If a large number of screen devices must be mounted or removed, the labour and time required can quickly build up.

Furthermore, in modern housebuilding, there is a trend for concealing as many construction elements as possible. There is a demand for uninterrupted and smooth surfaces both on the outside and inside of the dwelling. The presence of (protruding) fixing elements is considered not aesthetically pleasing. One solution is to provide secondary screening casings to cover the fixing elements. One disadvantage of such a solution is that the screening devices are wider than actually necessary and require more material. Also, this makes mounting and removal more complicated.

WO 2009/098433 A1 describes a bracket for mounting a rail for guiding a side edge of a zip-like screen, comprising: first and second elongate parts, wherein the first elongate part is configured to receive fixing means throughout for fixing the supporting surface of the first elongate part, and wherein the first and second elongate parts have mutually engaging profiles for releasable coupling of the second elongate part to the first elongate part when mounting the rail, as soon as the first elongate part has been fixed in position; characterised in that the first elongate part has an alignment flange for registering with a predefined part of a side of the zip-like screen which must be guided through a rail when mounted in the bracket.

EP 2 236 731 A2 describes a cover device of a cassette type with side guides, wherein the side guides are configured to allow mounting of the cassette above the side guides from a frontal direction.

US 2018/148974 A1 describes a top guide rail assembly for a retractable screen. The assembly comprises a U-shaped guide channel, a track fixing element for fixing the assembly to a support, and an outermost track element which can be connected to the fixing element, and a screen holding element inside the guide channel.

There is thus a need for a side guide for a screen device which offers a solution to one or more of the above-mentioned problems. Above all, there is a need for a side guide for a screen device which firstly can be mounted without screws but secondly in which the strength of the side guide is not jeopardised. As a result, the side guide can withstand loads, for example when the fabric is unrolled and a pressure is exerted on the screen, for example a wind load.

### SUMMARY

The present invention and the preferred embodiments thereof are intended to offer a solution to one or more of the above-mentioned disadvantages. For this, the present invention concerns a side guide for a screen device for rollable screens. In particular, the invention provides a side guide for a screen device to which a rollable screen can be attached. The invention furthermore concerns methods for mounting and removing the side guide.

In a first aspect, the invention concerns a side guide for a screen device with a screen which can be rolled up and unrolled. The side guide for a screen device comprises a hinge point and one or more of the following elements, preferably all the following elements:
a screen profile for receiving an edge of the screen;
a frame profile, preferably wherein the frame profile comprises the hinge point;
a cover profile comprising a hinge element; and
a coupling element comprising a flexible body which can be coupled to the frame profile.

The side guide for a screen device preferably comprises a hinge point and one or more of the following elements, preferably all the following elements:
a screen profile, preferably for receiving the edge of the screen;
a frame profile, preferably wherein the frame profile comprises the hinge point;
a cover profile, preferably comprising a hinge element provided with a protrusion; and
a coupling element, preferably one which can be coupled to the frame profile, preferably wherein the coupling element comprises a flexible body which is provided with an engaging protrusion.

The side guide is configured such that a rotation (or a combination of rotation and translation) of the hinge element over the hinge point ensures that the coupling element engages on the hinge element. The side guide is preferably configured such that rotation (or a combination of rotation and translation) of the hinge element over the hinge point ensures that the engaging protrusion of the coupling element engages on the protrusion of the hinge element.

The side guide for a screen device more preferably comprises one or more of the following elements, most preferably all the following elements:
a screen profile for receiving the edge of the screen;
a frame profile comprising a rear wall and at least two upright walls which form a space for receiving the screen profile; wherein a first upright wall is provided with a stop for the screen profile and a second upright wall (here also referred to as the hinge point wall) is provided with a hinge point;
a cover profile comprising a stop wall on which the hinge element is arranged at right angles; wherein the hinge element has a hinge side and a coupling side, with a protrusion which extends from the coupling side; and
a coupling element comprising a flexible body which can be coupled to the frame profile, wherein the body has an engaging protrusion.

The side guide for a screen device more preferably comprises one or more of the following elements, most preferably all the following elements:
a screen profile, preferably for receiving the edge of the screen;
a frame profile, preferably wherein the frame profile comprises the hinge point; preferably wherein the frame profile comprises a rear wall and at least two upright walls which form a space for receiving the screen profile; wherein a first upright wall is provided with a stop for the screen profile and a second upright wall (here also called the hinge point wall) is provided with a hinge point;
a cover profile, preferably wherein the cover profile comprises a stop wall on which the hinge element is arranged at right angles; preferably wherein the hinge element has a hinge side and a coupling side, and is provided with a protrusion which extends from the coupling side; and
a coupling element which can preferably be coupled to the frame profile; preferably wherein the coupling element comprises a flexible body which is provided with an engaging protrusion.

The side guide is preferably configured such that rotation (or a combination of rotation and translation) of the hinge element over the hinge point ensures that the stop wall of the cover profile forms a stop for the screen profile, and that the engaging protrusion of the coupling element engages on the protrusion of the hinge element.

In some embodiments, the cover profile comprises a cover plate for partial, preferably complete coverage of the coupling element. In some embodiments, the cover plate adjoins an upright wall of the frame profile.

In some embodiments, the frame profile comprises a third upright wall which, with the rear wall and the second upright wall (hinge point wall), forms a second space for receiving the coupling element.

In some embodiments, the flexible body of the coupling element comprises a foot which can be coupled to the frame profile. In some embodiments, the flexible body of the coupling element comprises a foot which can be pushed and/or clicked into the frame profile. In some embodiments, the coupling element comprises a further protrusion which is arranged between the coupling element and an upright wall of the frame profile. In some embodiments, the coupling element has a further (second) protrusion which is arranged between the coupling element and a third upright wall of the frame profile.

In some embodiments, the frame profile consists of at least two frame profile parts which can be coupled together. In some embodiments, the coupling element comprises a further (third) protrusion which is arranged between the coupling element and the second upright wall for clamping a frame profile part to another frame profile part.

In some embodiments, the flexible body of the coupling element is made of plastic.

In some embodiments, the side guide is screwless, i.e. free from screws.

In a further aspect, the invention concerns a method for mounting a side guide for a screen device according to one or more embodiments as described herein. The method comprises one or more, preferably all of the following steps:
(a) provision of a frame profile and coupling of a coupling element to the frame profile;
(b) placing of a screen profile, preferably below a stop of the frame profile;
(c) placing of a cover profile on a hinge point, preferably a hinge point of the frame profile; and
(d) rotation of the cover profile over the hinge point until the coupling element engages on the hinge element; preferably until an engaging protrusion of the coupling element engages on a protrusion of the hinge element, and preferably until a stop wall of the cover profile forms a second stop on the second upright wall.

In some embodiments, wherein the frame profile consists of at least two frame profile parts, step (a) comprises one or more, preferably all of the following steps:
(a.i) provision of a first frame profile part;
(a.ii) coupling of the coupling element to the first frame profile part;
(a.iii) placing of the second frame profile part in the first frame profile part; and
(a.iv) coupling of the second frame profile part to the first frame profile part by means of the coupling element; preferably by clamping of the second profile part against the first profile part by a frame clamping piece of the coupling element.

In a further aspect, the invention concerns a method for removing a side guide for a screen device according to one or more embodiments as described herein. The method comprises one or more, preferably all of the following steps:
(a′) provision of a mounted side guide for a screen device;
(b′) (back) rotation of a cover profile over a hinge point, preferably a hinge point of a frame profile, until a protrusion of a hinge element decouples from an engaging protrusion of a coupling element; preferably by exerting pressure on a stop formed by the stop wall of the cover profile;
(c′) removal of the cover profile from the hinge point;
(d′) optionally, removal of the screen profile;
(e′) optionally, decoupling and removal of the coupling element; and
(r) optionally, removal of the frame profile or the frame profile parts.

In a further aspect, the invention concerns a screen device comprising a side guide according to one or more embodiments as described herein.

In a further aspect, the invention concerns a use of a screen device according to one or more embodiments as described herein as a roller shutter, insect screen, (visual) partition, and/or sun blind.

### DESCRIPTION OF THE FIGURES

In order to present the features of the invention better, the attached figures show, without restrictive character, some preferred embodiments of the present invention. The numerical references are discussed in more detail in the examples. Throughout the figures, claims and examples, the following numbering is retained: 10 side guide; 80 rollable screen; 100 screen profile; 110 first damper; 120 second damper; 180 screen fixing means; 200 frame profile; 201 first frame profile part; 202 second frame profile part; 210 first upright wall; 215 stop; 216 downward stop; 220 second upright wall; 225 stop for hinge element; 230 third upright wall; 235 stop for cover plate; 250 hinge point; 290 rear wall; 291 first rear wall; 292 second rear wall; 300 cover profile; 315 stop; 316 downward stop; 340 cover plate; 350 hinge element; 355 protrusion of hinge element; 400 coupling element; 420 foot; 455 engaging protrusion; 460 second protrusion for coupling element; 470 third protrusion for coupling element.

FIG. 1 shows a first preferred embodiment of a side guide (10).

FIG. 2 shows a second preferred embodiment of a side guide (10).

FIG. 3 shows a method for mounting a side guide (10) according to a second preferred embodiment.

FIG. 4 shows a method for removing a mounted side guide (10) according to a second preferred embodiment.

FIG. 5A illustrates diagrammatically a method for mounting a side guide (10) according to a first preferred embodiment.

FIG. 5B illustrates diagrammatically a method for removing a side guide (10) according to a first preferred embodiment.

FIG. 6A illustrates diagrammatically a method for mounting a side guide (10) according to a second preferred embodiment.

FIG. 6B illustrates diagrammatically a method for removing a side guide (10) according to a second preferred embodiment.

FIG. 7 illustrates a coupling element (400) according to a preferred embodiment.

### DETAILED DESCRIPTION

Before the present system and method according to the invention are described, it must be understood that this invention is not restricted to specific systems and methods or combinations described, since such systems and methods and combinations may naturally vary. It should also be clear that the terminology used herein is not intended to be restrictive since the scope of the present invention is limited solely by the attached claims.

All documents cited in the present specification are fully included herein by means of reference.

As used below in this text, the singular forms “a”, “an”, “the” include both the singular and the plural unless the context clearly indicates otherwise.

The terms “comprise”, “comprises” as used below are synonymous with “inclusive”, “include” or “contain”, “contains” and are inclusive and open, and do not exclude secondary members, elements or methods not named. The terms “comprise”, “comprises” include the term “contain”.

The list of numerical values using a numerical range comprises all values and fractions within these ranges and also the end points cited.

The term “approximately” as used when referring to a measurable value such as a parameter, quantity, duration etc., is intended to include variations of ±10% or less, preferably ±5% or less, more preferably ±1% or less, and even more preferably ±0.1% or less, of and from the specified value insofar as the variations are suitable for functioning in the disclosed invention. It should be understood that the value to which the term “approximately” refers is also disclosed.

In the passages below, various aspects of the invention are defined in more detail. Each aspect thus defined may be combined with another aspect or aspects unless the contrary is clearly indicated. In particular, a feature described as “preferred” or “advantageous” may be combined with other features or properties described as “preferred” and/or “advantageous”. Reference in this specification to “one embodiment” or “an embodiment” means that the specified function, structure or characteristic described in connection with the embodiment is applicable in at least one embodiment of the present invention. Where the phrases “in one embodiment” or “an embodiment” are used at different points in this specification, they do not necessarily refer to the same embodiment, although this is not excluded. Also, the features, structures or characteristics described may be combined in any suitable fashion, as will be clear to a person skilled in the art on the basis of this description. The embodiments described and claimed in the claims may be used in any combination. In the present description of the invention, reference is made to the attached drawings which form part thereof and which illustrate specific embodiments of the invention. Figures in brackets or in bold linked to specific elements illustrate the elements concerned as an example without thereby restricting the elements. It must be understood that other embodiments may be used, and structural or logical changes may be made without leaving the scope of the present invention. The following detailed description should not be regarded as restrictive, and the scope of the present invention is defined by the attached claims.

Unless defined otherwise, all terms disclosed in the invention, including technical and scientific terms, have the meaning which would be normally understood by a person skilled in the art. As a further guideline, definitions are given for further explanation of terms which are used in the description of the invention.

A screen device as used herein concerns a system for erecting a screen which can be rolled up and unrolled. A screen device typically comprises a screen roller casing and two side guides. The screen usually concerns a flexible medium such as a fabric which can be rolled up or unrolled; examples of suitable types of screen material for the present invention are woven textile, glass fibres or fabric, plastic membrane or film etc. The screen is typically attached at one edge to a screen roller, whereby the screen can be rolled up over the screen roller. The screen may be attached to the two side guides by means of a screen profile. The side guides typically form a profile along which the screen can be guided during rolling up or unrolling.

A profile as used herein refers to a rigid and preferably elongate body typically used as a border of a frame. Depending on the desired embodiment, a profile may be both rounded or flat, with a wide or narrow wall, hollow inside or filled with a filler material, ribbed or smooth, and/or comprise ornamental finishes; the advantages and disadvantages of the various profile designs are assumed to be known to the skilled person. The profiles are typically made from a rigid material. This may for example be metal, preferably aluminium. Aluminium has many advantages as a profile material, namely it is both robust and lightweight, has good resistance to weathering and requires little maintenance. Other materials are however also suitable, and the advantages or disadvantages thereof are assumed to be known to the skilled person. In a first aspect, the invention concerns a side guide for a screen device with a screen which can be rolled up and unrolled. The side guide comprises a screen profile, a frame profile, a cover profile and a coupling element, and a hinge point. The frame profile preferably comprises the hinge point, and the cover profile comprises a hinge element. The hinge point as a rotation point may itself be situated at a point where no material is present. In some embodiments, the hinge point forms part of another profile, optionally a hinge point profile.

The screen profile is typically configured to guide the screen during rolling up and unrolling. The screen profile optionally comprises a means for receiving the edge of the screen, also called a screen fixing means; and/or optionally two dampers arranged for example on either side of the screen fixing means. Typically, a thickening is provided at the edge of the screen (for example in the form of a half zip) and this thickening is received in the screen fixing means.

The frame profile is typically configured to house the other parts of the side guide. The frame profile preferably comprises the hinge point. The frame profile preferably comprises a rear wall and at least two upright walls, in particular a first upright wall and a second upright wall; wherein the first upright wall comprises a stop; wherein the second upright wall comprises a hinge point. The rear wall and the at least two upright walls preferably form a space for receiving the screen profile.

The cover profile is typically configured to cover other parts of the side guide. The frame profile according to the invention comprises a hinge element. The cover profile preferably comprises a stop wall on which the hinge element is arranged at right angles; wherein the hinge element can rotate over the hinge point of the frame profile. The hinge element may furthermore be provided with a protrusion; namely the hinge element protrusion. Preferably, the hinge element has a hinge side and a coupling side; wherein the hinge element comprises a protrusion which extends from the coupling side; and wherein the stop wall forms a stop on the second upright wall of the frame profile after rotation (or a combination of rotation and translation) of the hinge element over the hinge point.

The coupling element is typically configured to couple the other parts of the side guide. The coupling element preferably comprises a flexible body; wherein the flexible body can be coupled to the frame profile. The flexible body may furthermore be provided with an engaging protrusion; namely, the flexible body protrusion. The flexible body preferably comprises an engaging protrusion; wherein the engaging protrusion of the coupling element engages on the protrusion of the hinge element after rotation (or a combination of rotation and translation) of the hinge element over the hinge point. The side guide is thus preferably configured such that rotation of the hinge element over the hinge point ensures that the engaging protrusion of the coupling element engages on the protrusion of the hinge element.

Secondary embodiments and the advantages thereof are described below.

The profiles of the side guide described herein may be mounted without screws; preferably, the entire side guide is screwless. The screen casing for example may however comprise screws. Screwless here refers to the use of fixing elements which in mechanical fashion connect together two separate parts and keep them connected. Screwless also means the absence of use of fixing elements equivalent to screws, such as nails, pins and similar. The use of fixing elements for fixing or anchoring the frame profile to an external structure such as a wall is not regarded as forming part of the side guide; these fixing elements do not form an essential part of the mounting. In some embodiments, the side guide and/or the screen device comprise fixing elements for fixing or anchoring the frame profile to an external structure, wherein the remainder of the side guide is preferably screwless.

As indicated above, screws typically form the weakest element in a side guide of a device under (wind) loading of the screen. Because the present side guide comprises a hinge element, the stability of the device is accordingly improved. A secondary advantage of the hinge element is also that the hinge element is typically established over the entire length of the side guide, whereas screws are provided only locally and hence only offer strength locally. In this way, the device can better resist external loads such as high wind loads on the screen, and can absorb the loads better and more evenly. The absence of screws also offers the opportunity for a more (aesthetically) pleasing finish. It is possible to provide certain finishes which were previously not possible due to the presence of screws and screw openings.

Furthermore, the side guides allow the screen to be mounted in a window or door in a simpler and more user-friendly fashion. There is no need for specific tools such as screwdrivers or hammers. In addition, the side guide may allow simple removal, for example when the screen must be replaced. The absence of screws may also reduce the chance of (accidental) damage to the profiles and/or screen.

The screen profile is typically configured to guide the screen in rolling up and unrolling. The screen profile optionally comprises a means for receiving the edge of the screen, also referred to as a screen fixing means. Typically, a thickening is provided on the edge of the screen (for example in the form of a half zip) and this thickening is received in the screen fixing means.

Optionally, the screen profile comprises one or more dampers (sprung elements), for example two dampers, arranged on either side of the screen profile. These dampers are preferably made of foam. Preferably, a first upright wall is provided with a stop for a damper of the screen profile. Preferably, the side guide is configured such that rotation (or a combination of rotation and translation) of the hinge element over the hinge point ensures that the stop wall of the cover profile forms a stop for a damper of the screen profile.

In some embodiments, the screen profile is provided with at least two dampers. The dampers are preferably sprung elements. These are typically used to tension the screen so that no rippling occurs and the screen appears straight. The rear wall of the frame profile in combination with the two stops (namely a first stop of the frame profile and a second stop formed by the stop profile) may form a chamber in which the screen profile is present and the optional dampers damp the screen profile. The dampers may assume different forms such as rectangular or circular.

The at least two dampers are preferably arranged on either side of the optional screen fixing means; the screen fixing means with the screen is situated between the at least two dampers. The screen can preferably be moved in and out of the frame profile along the stop of the frame profile and the stop of the cover profile after mounting of the side guide.

The frame profile is typically configured to house other parts of the side guide. The frame profile forms a space suitable for placing the screen profile; the screen profile is at least partially and preferably completely received in the frame profile. The frame profile preferably comprises a rear wall and at least two upright walls, in particular a first upright wall and a second upright wall; wherein the first upright wall comprises a stop; and wherein the second upright wall comprises a hinge point. The rear wall and the at least two upright walls preferably form a space for receiving the screen profile. By producing a frame profile with a rear wall and two upright walls, an elongate channel is formed which creates a cavity in which the screen profile can be received. The screen profile is thereby largely concealed from view. The other parts of the side guide may be placed in the frame profile in a similar fashion. The screen profile is placed in the frame profile so as to allow the rollable screen to be unrolled and rolled up.

At least one upright wall may be provided with a first stop; this is then also known as the first stop wall. The first stop serves for blocking the screen profile (for example a flank of the screen profile) at least perpendicularly to the rolling direction of the screen and/or perpendicularly to the rear side of the frame profile. In some embodiments, the first stop serves to block the first damper at least perpendicularly to the rolling direction of the screen and/or perpendicularly to the rear side of the frame profile. This stop typically also runs sideways and is referred to as a sideways stop. The term “sideways” in the context of stops should be interpreted as the direction of the side edge of the frame profile; sideways direction of a side wall. Sideways may correspond to a direction which runs almost perpendicularly to the upright wall. The stop may also however run obliquely to the upright wall.

Optionally, the first sideways stop may also be provided with a downward stop; the downward stop serves to block the first damper at least in the sideways movement over the rear wall of the frame profile, and to form a stop for the screen profile in order to prevent the damper from being overloaded and consequently deformed plastically. The downward stop typically runs downward and is also called a downward stop. The term “downward” in the context of stops should be interpreted as being towards the lower edge of the frame profile, i.e. towards the rear wall of the frame profile. This direction may run parallel to the upright wall and the damper, but the second stop may also run obliquely downward.

Preferably, the downward stop is shorter than the stop. The (sideways) stop and the downward stop may thereby form a hook-like structure in which the screen profile remains engaged. In this way, mounting of the screen profile is simplified and is less labour-intensive. In addition, such a hook-like structure is particularly useful when the frame profile is situated in a place with difficult access.

The frame profile preferably comprises the hinge point. At least one upright wall (i.e. the second upright wall, which is not the above-mentioned wall with the stop) may be provided with a hinge point; it is then also known as the hinge point wall. The hinge point forms a (continuous or interrupted) surface over which the hinge element of the cover profile can rotate. The surface of the hinge point may assume different shapes to allow such rotation. Preferably, the hinge point is partially circular; for example, wherein the surface coming into contact with the hinge element is circular and the surface not coming into such contact is angular. Preferably, the hinge point is fully circular; the part of the hinge point in contact with the hinge point wall may partially interrupt the circle form. The surface of the hinge point may also be provided with grooves or ribs to increase the friction between the hinge point and the hinge element. To save material, it is possible to produce the hinge point from several parts which together form a hinge point. The hinge point as a rotation point may in itself be situated at a place where no material is present. The rotation point is then determined by material present around this. The frame profile may furthermore comprise a third upright wall; the frame profile then comprises a rear wall and three upright walls. The third wall together with the rear wall and the hinge point wall (second upright wall) form a second space for placing the coupling element. The hinge point wall thereby forms an intermediate wall which divides the frame profile into two spaces; namely a first space for placing the screen profile and a second space for placing the coupling element. The coupling element space is typically smaller than the screen profile space. At least one of the upright walls may form a side wall of the frame profile; the frame profile then comprises a rear wall, a side wall and an upright wall. The side wall in such an embodiment is preferably provided with a stop. The screen profile may therefore be hooked into the side wall, simplifying mounting. Because the optional dampers are typically sprung elements made of foam, the engagement form is not strictly defined. In addition, the optional dampers are preferably only placed periodically.

If the frame profile comprises three upright walls, two of the three upright walls may form side walls of the frame profile. Optionally, further upright walls may be provided, for example if there is need for further intermediate spaces.

One wall of the frame profile may function as a stop for the hinge element, for example the second upright wall (hinge point wall), and is herein defined as the stop wall. Alternatively or additionally, a wall of the frame profile may comprise a stop for the hinge element and/or the cover plate, for example the third upright wall. In this way, most forces are concentrated on the frame profile instead of on the coupling element.

The frame profile may be produced as a single unit; preferably extruded in one piece. The frame profile may also however be formed from several frame profile parts, wherein the frame profile parts are coupled together to form the frame profile. Preferably, the frame profile comprises at least two couplable frame profile parts. In such an embodiment, the parts of the frame profile may be distributed over the two or more frame profile parts. Preferably, a first frame profile forms the rear wall on which a coupling element can be coupled, and a second frame profile is provided with two upright walls which form the stop wall and the hinge point wall.

The frame profile may be provided with means or arrangements for fixing or anchoring the frame profile to an external structure such as a wall. The fixing may be permanent, for example followed by or combined with gluing, or non-permanent, e.g. simply screwed. The fixing typically uses fixing elements (e.g. screws, anchoring points, flanges etc.) which may be placed in the arrangements (e.g. screw openings, grooves, hooks etc.). The use of fixing elements for fixing the frame profile is not considered part of the side guide; the fixing elements do not form an essential part of the mounting.

The cover profile is typically configured to cover the other parts of the side guide. The frame profile according to the invention comprises a hinge element. The cover profile preferably comprises a stop wall on which the hinge element is arranged at right angles; wherein the hinge element can rotate over the hinge point, preferably over the hinge point of the frame profile. Preferably, the hinge element has a hinge side and a coupling side; wherein the hinge element comprises a protrusion which extends from the coupling side; and wherein the stop wall forms a stop on the second upright wall of the frame profile after rotation (or a combination of rotation and translation) of the hinge element over the hinge point.

The cover profile preferably comprises at least one wall. When the cover profile is placed on the frame profile, it forms a stop on the upright wall of the frame profile provided with the hinge point; it is therefore also known as the stop wall. The stop wall may block the screen profile at least in the direction perpendicularly to the rolling direction of the screen and/or perpendicularly to the rear side of the frame profile. Optionally, the stop wall may furthermore be provided with a downward stop; the downward stop serves to form a stop for the screen profile in order to block the second damper at least in the sideways movement over the rear wall of the frame profile. The downward stop typically runs downward, and is therefore also called a downward stop.

Preferably, the downward stop is shorter than the stop wall. The stop wall and the downward stop may thereby form a hook-like structure in which the screen profile remains engaged.

The at least one stop wall is preferably provided with a hinge element which is arranged at right angles to the at least one stop wall of the cover profile. The term “at right angles” in the context of the hinge element should be interpreted as almost perpendicular to a surface of the stop wall. After rotation of the hinge element (or a combination of rotation and translation), the stop wall may form an almost right angle relative to the hinge point wall in order to form a virtually perpendicular stop. The stop here runs in the direction of the second damper.

The hinge element of the stop wall preferably has at least two sides on two opposing edges. The hinge element may firstly have a hinge side which allows the hinge element to rotate over the hinge point; the hinge element forms a rotatable coupling point together with the hinge point. The hinge side may also be regarded as the front of the hinge element. Preferably, the hinge element has a shape which corresponds to the surface of the hinge point; this ensures a good fit which allows easier and smoother rotation.

If the surface of the hinge point is (partially) circular, the hinge point may have an arcuate surface (on the hinge side). Preferably, the arcuate surface of the hinge element has a radius of curvature which corresponds to a (partially) circular surface of the hinge point. The coupling side may assume a similar arcuate form to the hinge side; the hinge element therefore has a hook-like shape. A hook-like shape allows the hinge element to be firmly hooked to the hinge point in a simple fashion and to absorb extreme wind loads.

The hinge element may furthermore have a coupling side along which coupling to the coupling element is possible. On the coupling side, preferably a protrusion is provided which extends from the coupling side; this is then also called the hinge element protrusion. The coupling side may also be regarded as the back of the hinge element. The protrusion may be rigid or flexible. The protrusion may be formed at any point on the coupling side as long as coupling to the protrusions of the coupling element remains possible. Preferably, the protrusion extends almost out of the middle of the hinge element; the protrusion thus divides the hinge element into two equal or unequal parts.

The cover profile may comprise a cover plate which can cover the coupling element when the cover profile is placed on the frame profile. The cover plate at least partially and preferably completely covers the coupling element. The cover plate thus ensures that the coupling element is protected, which may be important when the device is placed outdoors. The cover plate preferably adjoins the side wall of the frame profile; this may significantly reduce or even completely prevent the penetration of water or dust into the device.

Preferably, the cover plate lies in the extension of the stop wall; together they form one wall of the cover profile. Alternatively, the cover plate may form a separate wall which may be useful if a specific angle is required to achieve a good closure. Such a cover plate has the advantage that it can be firmly clicked in place. The greater the forces on the unrolled screen, the greater the forces acting on the screen profile, and the more firmly the cover plate is secured. In addition, most forces are distributed over the length of the various profiles without loading the coupling element.

The coupling element is typically configured to couple the other parts of the side guide. The coupling element preferably comprises a flexible body; wherein the flexible body can be coupled to the frame profile. The flexible body preferably comprises an engaging protrusion; wherein the engaging protrusion of the coupling element engages on the protrusion of the hinge element after rotation (or a combination of rotation and translation) of the hinge element over the hinge point.

The term “flexible” as used herein refers to a material property of the body for demonstrating elasticity or resilience when a specific force is exerted on the body or part of the body. The body may deform partially under pressure, but on removal of the pressure may return to the original form. The flexibility is important because this allows click or clamp couplings to be formed between firstly the coupling element and secondly the profiles described above.

Any plastic material may be used. Since most forces are distributed over the profiles without loading the coupling element, a material may be selected which is flexible but need not be as stiff or durable as the profiles. To guarantee good flexibility, the body may be made of a flexible material; preferably plastic, preferably POM (polyoxymethylene). In some embodiments, the coupling element comprises a leaf spring.

The coupling element is preferably as large as the space available. The coupling element may be formed by injection moulding. Preferably, a coupling element is provided along the length of the side guide at regular intervals, for example 1 coupling element every X cm, wherein X is at least 20 and at most 100, for example at least 30 and at most 80, for example at least 40 and at most 60, for example around 50. The optional dampers are preferably also provided at regular intervals, for example 1 damper every Y cm, wherein Y is preferably at least 10 and at most 100, for example at least 20 and at most 75, for example at least 30 and at most 50, for example around 40. In some embodiments, X is approximately equal to Y.

The coupling element preferably comprises a first protrusion which is positioned to make contact with the protrusion of the hinge element; it is then also called the (first) coupling element protrusion. Rotation (or a combination of rotation and translation) of the hinge element over the hinge point ensures that the coupling element protrusion blocks the hinge element protrusion. By exerting a specific pressure on the coupling element, the coupling element body and/or the coupling element protrusion may deform, allowing the hinge element protrusion to pass. In this way, the hinge element may rotate further over the hinge point. Bridging of this blockade is regarded as a click coupling.

The coupling element protrusion is furthermore preferably provided with an engagement point on which the hinge element protrusion engages when the hinge element is rotated back; it therefore forms an engaging protrusion. The presence of the engagement point ensures that the hinge element cannot come loose when tension is exerted on one or more profiles.

The coupling element may preferably comprise a further (second) protrusion which forms a bridge between the hinge point wall of the frame profile and the body of the coupling element. This protrusion may serve to guide the hinge element in placing and rotation over the hinge point. If the hinge profile consists of several frame parts, the protrusion may also serve to couple the frame parts together.

The coupling element may preferably comprise a further (third) protrusion which forms a bridge between a side wall of the frame profile and the body of the coupling element. This protrusion may ensure that the topmost part of the coupling element is less resilient.

The coupling element can preferably be coupled to the frame profile, preferably by click connection. The coupling may be created in that the coupling element is provided with a foot which can be coupled to the frame profile. The coupling may for example be created by grooves provided in the frame profile, into which the foot can be clicked. Alternatively, the frame profile may be provided with hook elements on which the foot can be hooked. This has the advantage that the coupling elements can be arranged in a vertical side guide without coming loose or falling or sliding down.

All the above profiles and elements may be produced in one piece, or may be produced in separate parts. One example is the frame profile which may consist of several frame profile parts. Preferably, the cover plate is produced in one piece. Preferably, each coupling element is produced in one piece.

In a further aspect, the invention concerns a method for mounting a side guide for a screen device, preferably according to one or more embodiments as described herein. The method comprises one or more, preferably all of the following steps:
(a) provision of a frame profile and coupling of a coupling element to the frame profile;
(b) placing of a screen profile, preferably below a stop of the frame profile; preferably wherein a first damper of the screen profile is placed below the first stop;
(c) placing of a cover profile on a hinge point, preferably a hinge point of the frame profile; and
(d) rotation of the cover profile over the hinge point until the coupling element engages on the hinge element; preferably until an engaging protrusion of the coupling element engages on a protrusion of the hinge element, and preferably until a stop wall of the cover profile forms a second stop on the second upright wall.

All steps of the method may be carried out without the use of fixing means. The advantage of the method is that mounting may take place more easily, in a more user-friendly fashion, and/or more quickly. In addition, the profiles may be mounted and removed equally easily.

The frame profile provided may be attached or anchored to an external structure, such as a wall, a window or a door opening. Mounting may thereby be simplified by placing and/or coupling all parts to a stable frame profile. This fixing may optionally be performed using fixing means; these fixing means however do not form part of the method for mounting the side guide for a screen device.

When the frame profile comprises at least two frame profile parts, step (a) comprises one or more, preferably all of the following steps:
(a.i) provision of a first frame profile part;
(a.ii) coupling of the coupling element to the first frame profile part;
(a.iii) placing of the second frame profile part in the first frame profile part; and
(a.iv) coupling of the second frame profile part to the first frame profile part by means of the coupling element; preferably by clamping of the second profile part against the first profile part by a frame clamping piece of the coupling element.

If the frame profile comprises more than two frame profile parts, the above steps may be repeated until all frame profile parts are coupled together to form the frame profile.

In a further aspect, the invention concerns a method for removing a side guide for a screen device, preferably according to one or more embodiments as described herein. The method comprises one or more, preferably all of the following steps:
(a′) provision of a mounted side guide;
(b′) (back) rotation of a cover profile of a hinge element over a hinge point, preferably a hinge point of a frame profile, preferably until a protrusion of the hinge element decouples from an engaging protrusion of the coupling element; preferably by exerting pressure on a stop formed by the stop wall of the cover profile;
(c′) removal of the cover profile from the hinge point;
(d′) optionally, removal of the screen profile;
(e′) optionally, decoupling and removal of the coupling element; and
(f′) optionally, removal of the frame profile.

When the frame profile comprises 2 frame profile parts, the method for removal comprises one or more, preferably all of the following steps:
(a′) provision of a mounted side guide;
(b′) (back) rotation of a cover profile of a hinge element over a hinge point, preferably a hinge point of a frame profile, preferably until a protrusion of the hinge element decouples from an engaging protrusion of the coupling element; preferably by exerting pressure on a stop formed by the stop wall of the cover profile;
(c′) removal of the cover profile from the hinge point;
(d′) optionally, removal of the screen profile;
(e′) optionally, removal of a first frame profile part;
(f′) optionally, decoupling and removal of the coupling element; and
(g′) optionally, removal of a second frame profile part.

All steps of the method may be carried out without removing the fixing means, which reduces the chance of damaging one or more parts of the side guide. The method has the advantage that removal may take place more easily, in a more user-friendly fashion, and/or more quickly.

The advantage of the side guide is that forces exerted on the profiles or the screen have no impact on the device irrespective of the location or angle of the force. This means that the screen can always be rolled up and unrolled without risk that the screen profile or device will come loose. The force is absorbed by the stops which transfer the force to the frame profile. In addition, greater forces only mean a firmer coupling of the cover profile. Before removal, conversely it is sufficient simply for no wind forces to be provided on the screen (for example because the screen is rolled up), whereby the cover profile can easily be clicked open by pressing thereon.

The easiest way of removing the described device is to exert a force on the stop formed by the stop wall of the cover profile, in other words by pressing on the second stop. In this way, the flexible coupling element is pressed back so that the protrusion of the coupling element no longer blocks the protrusion on the coupling side of the hinge element, and the hinge element can be rotated over the hinge point. After rotation (or a combination of rotation and translation), the cover profile can easily be detached by lifting it in the direction away from the frame profile. Once the cover profile has been removed, all underlying elements can in turn be released or replaced. Because dismantling does not always require complete removal of all parts, some steps are regarded as optional. If only the cover profile is to be removed, for example because of a damaged surface, the screen profile and coupling element can be held in place. If the screen profile is to be removed, for example to replace the screen profile, step (d′) is considered not optional. An equivalent reasoning applies to removal of the coupling element. To replace the screen, the side guide can be removed fully except for the frame profile. In a third aspect, the invention concerns a screen device comprising a side guide according to one or more embodiments as described herein. Preferably, the screen device comprises the combination of a screen casing and two side guides as described herein.

In a fourth aspect, the invention concerns a use of a screen device according to one or more embodiments as described herein, for fixing a screen which can be rolled up and unrolled. The screen device may be used as a roller shutter, fly screen, partition and/or sun blind, for example in windows or doors.

### EXAMPLES

By way of example, reference is made to the figures. The embodiments illustrated in the figures concern preferred embodiments of the present invention and should in no sense be interpreted as a restriction.

### Example 1: Side Guides

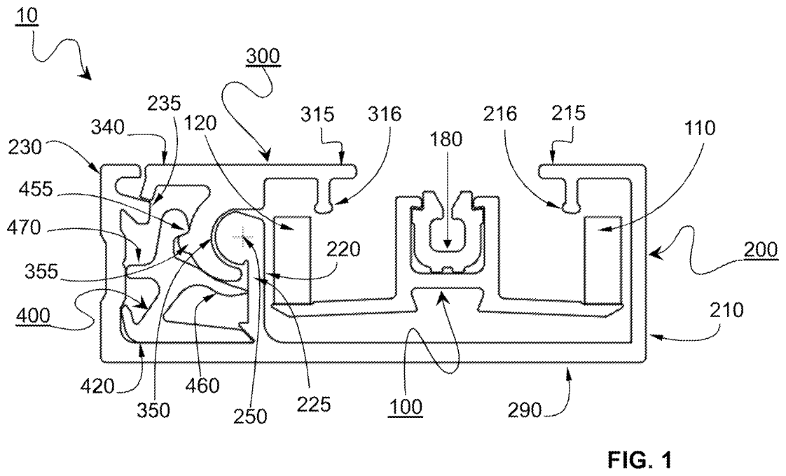

FIG. 1 shows a depiction of a side guide (10) according to a first embodiment with one frame profile (200).

In this embodiment, a screen profile (100) is completely received in a frame profile (200). When the screen profile (100) is placed in the frame profile (200), a first damper (110) is placed against a first upright wall of the frame profile (200); the first upright wall (210) is provided with a sideways stop (215) which completely covers the damper (110). The first upright wall (210) in this embodiment also forms the side wall of the frame profile (200).

Furthermore, a second damper (120) of the screen profile (100) is placed against a second upright wall (220) of the frame profile (200); the second upright wall (220) is provided with a hinge point (250). The hinge point (250) is oriented away from the second damper (120). The second upright wall (220) also functions as a stop wall (225) for the hinge element.

The screen profile is thus surrounded on four sides by the frame profile (200) and the cover profile (300), with an opening on the top. The opening ensures access to the screen, whereby the screen can be rolled up and unrolled. The screen is attached to the screen profile (100) by means of a screen fixing means (180).

Movement of the screen out of the side guide is blocked by means of two sideways stops (215, 315) which are arranged over the two dampers (110, 120). The two sideways stops (215, 315) are optionally furthermore provided with two downward stops (216, 316). The first downward stop (216) may serve as an attachment point when the screen profile (100) is placed in the frame profile (200).

The second sideways stop (315) is formed by the stop wall of the cover profile (300). The cover profile (300) is provided with a hinge element (350) which is arranged at right angles to the stop wall of the cover profile (300). The hinge element (350) has a hinge side which preferably forms the front edge of the hinge element. The hinge element (350) may be placed along the hinge side on the hinge point (250) and then rotate downwards over the hinge point (250). On downward rotation, the surface of the stop wall comes to stand parallel with the first stop (215), preferably in the same plane formed by the surface of the first stop (215). In this way, a second sideways stop (315) is formed at the same height as the first sideways stop (215).

The hinge element (350) furthermore also has a coupling side which preferably forms the rear edge of the hinge element (350). The coupling side is provided with a protrusion (355) which extends from the coupling side. On rotation, this protrusion (355) comes into contact with an engaging protrusion (455) of a coupling element (400) which is arranged along the hinge element (350). Contact between the two protrusions (355, 455) blocks rotation of the hinge element (350). However, because the coupling element (400) is flexible, this contact can be bridged by exerting a predefined pressure on the cover profile (300) during rotation. In this way, the engaging protrusion (455) of the coupling element (400) is bent or shifted, allowing the hinge element (350) to rotate further. Bridging of this contact is regarded as a click coupling.

In this embodiment, the coupling element (400) is completely received in a frame profile (200). The frame profile (200) forms a space provided to this end by part of the rear wall (290), the second upright wall (220), and a third upright wall (230) of the frame profile (200); the third upright wall may form a second side wall of the frame profile (200).

The coupling element (400) comprises a flexible body which is coupled to the frame profile (200). In particular, the body of the coupling element (400) may be coupled by means of a foot (420) which can be placed in a wall of the frame profile (200). The flexible body of the coupling element (400) furthermore comprises a second protrusion (460) which forms a bridge between the second upright wall of the frame profile (200) and the body of the coupling element (400). When the coupling element (400) is placed in the frame profile (200), the protrusion comes into contact with the hinge point (250) and the coupling element is secured.

The flexible body of the coupling element (400) furthermore comprises a third protrusion (470) which forms a bridge between the third upright wall of the frame profile (200) and the body of the coupling element (400).

Finally, the coupling element (400) is covered by a cover plate (340) of the cover profile (300). Preferably, the cover plate (340) lies in the same plane as the stop wall forming the first stop (215); it therefore forms the same stop wall of the cover profile (300). The second side wall of the frame profile (200), here corresponding to the third upright wall (230), may be provided with a sideways stop (235) which blocks the cover plate (340) on rotation of the hinge element (350) over the hinge point (250). Alternatively or additionally, the second upright wall (220, 225) can block the rotation of the hinge element.

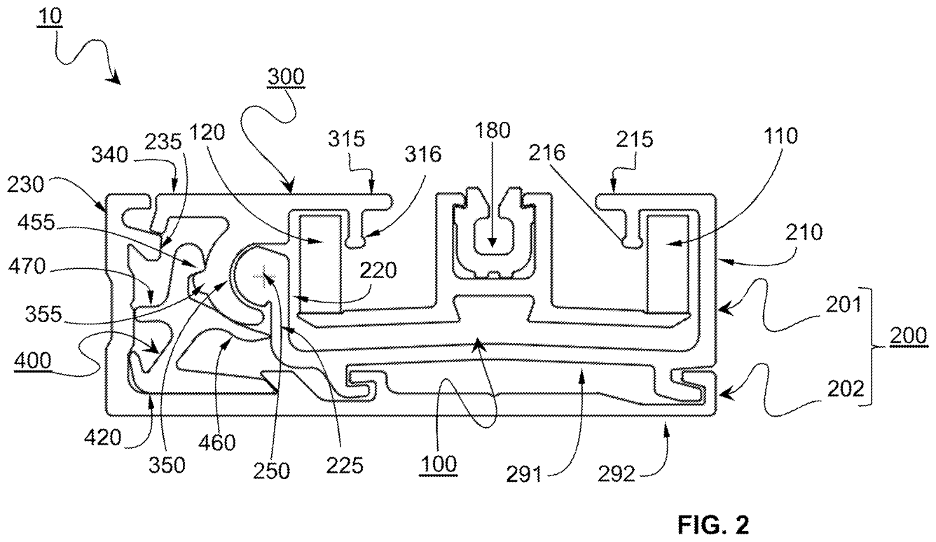

Similarly to FIG. 1, FIG. 2 shows an illustration of a side guide (10) according to a second embodiment, in which the frame profile (200) is formed by coupling of two frame profile parts (201, 202).

In this embodiment, the first frame profile part (201) forms a rear wall (291) and two upright walls. The first upright wall (210) of the first frame profile part (201) is provided with the first stop and forms a side wall of the coupled frame profile (200). The second upright wall (220) of the first frame profile part (201) is provided with the hinge point (250).

The second frame profile part (202) comprises a rear wall (292) and an upright wall. The upright wall of the second frame profile part (202) forms a side wall of the coupled frame profile (200). The rear wall (292) of the second frame profile part (201) is provided with grooves for coupling of the coupling element (400).

The coupling between the first frame profile part (201) and the second frame profile part (202) may be created in various ways. For example, grooves and/or hook elements may be provided on the underside of the first frame profile part (201) and on the top side of the second frame profile part (202). In this way, the first frame profile part (201) may be pushed into the second frame profile part (202).

This coupling may then be secured by the coupling element (400) which is coupled to the second frame profile part (202) by means of a foot (420). In particular, the coupling element (400) may be provided with a protrusion (460) which forms a bridge between an upright wall of the first frame profile part (201) and the body of the coupling element (400). This protrusion (460) exerts a pressure on the first frame profile part (201) so that this is held in place.

### Example 2: Mounting and Removal of the Side Guide

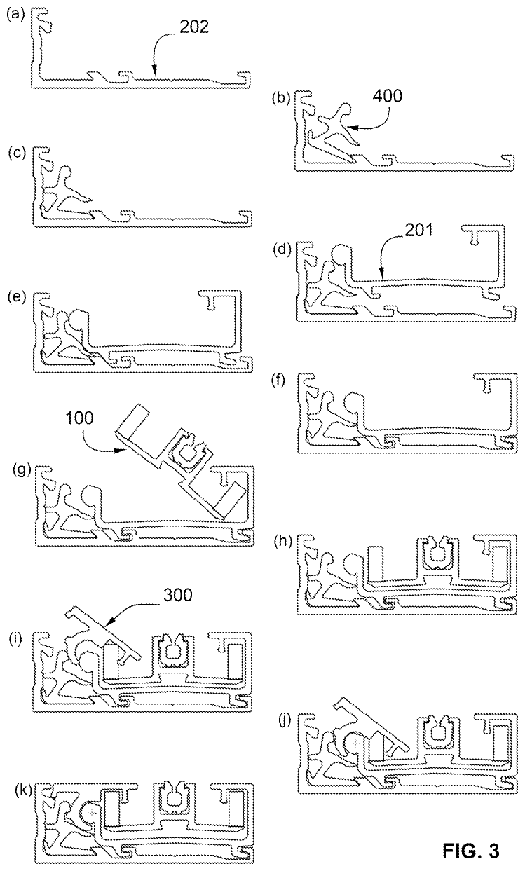

FIG. 3 illustrates diagrammatically how a side guide (10) may be mounted according to a preferred embodiment. For detailed discussion of all parts of the side guide (10), reference is made to FIG. 2 and example 1. The embodiment illustrated has a side guide (10) wherein the frame profile (200) is formed by coupling two frame profile parts (201, 202). The arrows illustrate a direction of movement.

FIG. 3(a) shows the placing of the second frame profile part (202). The placing may refer to fixing of the frame profile part (202) to an external structure such as a wall. This fixing is typically carried out via the rear wall of the frame profile part (202).

FIG. 3(b) shows the first step in coupling a flexible coupling element (400) to the second frame profile part (202). The coupling element (400) comprises a foot which can be clamped between an upright side wall of the frame profile and a rigid protrusion on the rear wall of the frame profile part (201). By partially rotating the coupling element (400) and pressing it into the space provided, a coupling is created as illustrated in FIG. 3(c). The coupling described is a click coupling. As shown in FIG. 3(d), the first frame profile part (201) can then be coupled to the second frame profile part (202). The first frame profile part (201) comprises two hook-like grooves on the surface of the rear wall, pointing towards the second frame profile part (202), and the second frame profile part (202) comprises two complementary grooves on the surface of the rear wall, pointing towards the first frame profile part (201).

When the first frame profile part (201) is placed on the second frame profile part (202), a protrusion of the coupled coupling element (400) makes contact with a side wall of the first frame profile part (201). FIG. 3(e) then shows that when a specific force is exerted on the first frame profile part (201), the protrusion is bent downward, whereby the first frame profile part (201) can be pressed into the grooves provided on the second frame profile part (202). This insertion ensures that the pressure on the coupling element is relieved and the protrusion can return to the original position as shown in FIG. 3(f). The protrusion thus forms a bridge between the coupling element on one side and the side wall of the first frame profile part (201) on the other. The coupling described is a click coupling.

FIG. 3(g) shows how the screen profile (100) with dampers can be placed in an interior space formed by the rear wall and two upright side walls of the first frame profile part (201). Because one side wall is provided with a stop, the screen profile (100) is placed at an angle. Once a first damper hooks under the stop, the screen profile (100) can be turned to the desired position as shown in FIG. 3(h).

FIG. 3(i) shows the placing of the cover profile (300) on the screen profile. The cover profile is placed at an angle so that a wall provided with a stop of the cover profile can slide over the second damper. This placing ensures that the hinge element comes to rest above the hinge point.

When the cover profile is pushed in the direction of the coupling element as shown in FIG. 3(j), the hinge element engages on the hinge point, whereby rotation is possible along the hinge side. A protrusion of the coupling element however prevents further rotation.

Because the coupling element is flexible, the exertion of a specific pressure pushes the protrusion aside, whereby the hinge element can be rotated over the hinge point. FIG. 3(k) shows that when the protrusion of the hinge element is rotated past the protrusion of the coupling element, the protrusion of the coupling element again engages on the protrusion of the hinge element. This blocks an accidental back-rotation of the hinge element. The coupling described is a click coupling.

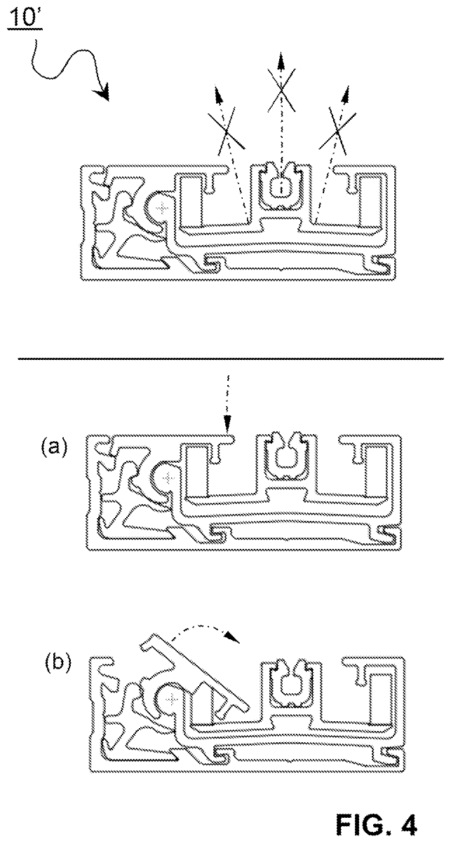

Following FIG. 3, FIG. 4 illustrates how the mounted side guide (10′) can be removed. After mounting, the side guide forms a fixed coupling between the profiles and the coupling element.

As shown in FIG. 4, a tensile force exerted on the screen profile has no impact on the arrangement, irrespective of contact point or tension angle. This ensures that the screen can be exposed to wind forces without risk of the screen profile or cover profile coming loose. The tensile forces are absorbed by the stops which transfer the force to the frame profile.

FIG. 4(a) however shows that removal can be performed simply by exerting a pressure on the stop wall of the cover profile. This ensures that the engageable coupling between the protrusion of the coupling element and the protrusion of the hinge element is bridged by pushing the flexible body of the coupling element aside. This allows back-rotation of the hinge element as shown in FIG. 4(b).

Once rotated, the cover profile can easily be removed. Further removal of the side guide can then take place by performing the steps of FIG. 3 in reverse order, namely from FIG. 3(i) to FIG. 3(a).

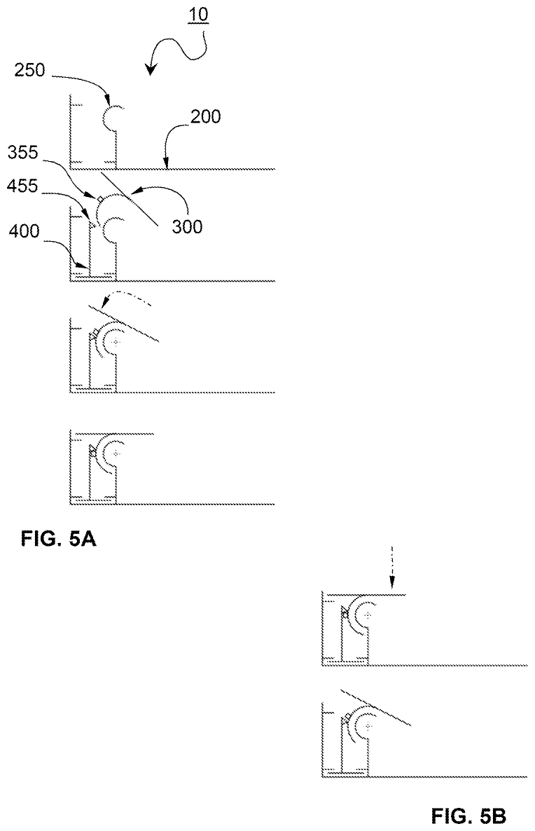

FIG. 5(a) shows a concise diagrammatic depiction of the method illustrated in FIG. 3 for mounting an embodiment in which the frame profile (200) of the side guide (10) consists of a single part, and the coupling element (400) is configured as a leaf spring.

FIG. 5(b) then shows removal of a mounted side guide (10).

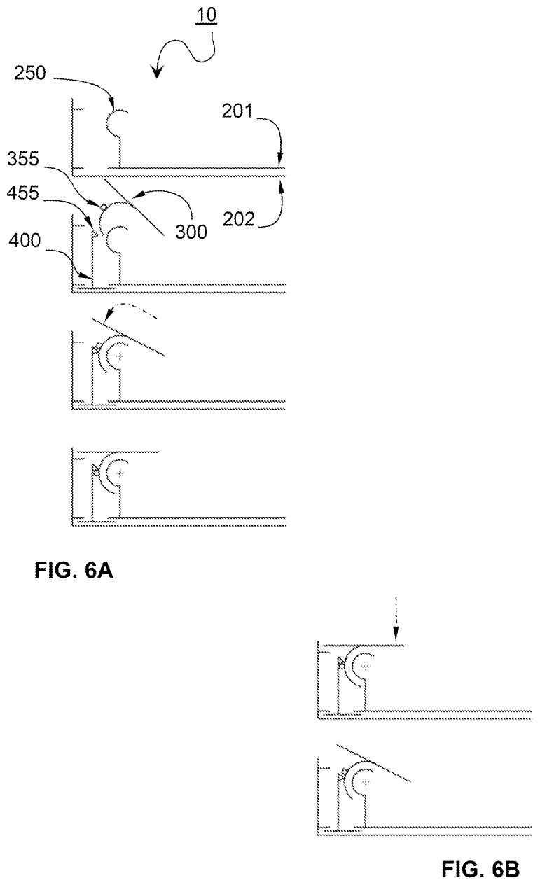

FIG. 6(a) shows a concise diagrammatic depiction of the method illustrated in FIG. 3 for mounting an embodiment in which the frame profile (200) of the side guide (10) consists of two frame profile parts (201, 202), and the coupling element (400) is configured as a leaf spring. FIG. 6(b) then shows removal of a mounted side guide (10).

### Example 3: Coupling Element

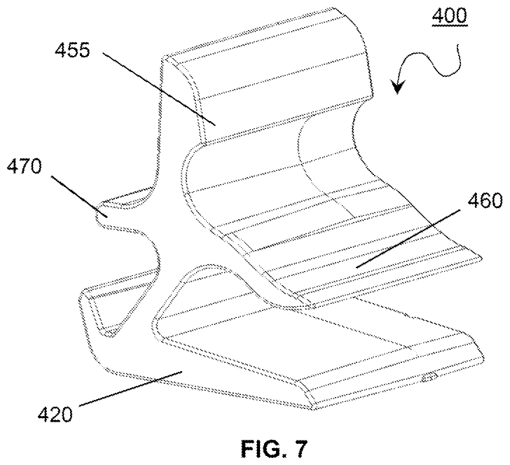

FIG. 7 illustrates a coupling element (400) according to a preferred embodiment.

The coupling element (400) has a flexible body, for example made of plastic, which can be coupled to the frame profile (200). The flexible body comprises a foot (420) which can be placed in a wall of the frame profile (200). The flexible body also comprises an engaging protrusion (455) which can engage on the protrusion (355) of the hinge element (350). The flexible body also comprises a second protrusion (460) which forms a bridge between the second upright wall of the frame profile (200) and the body of the coupling element (400). The flexible body also comprises a third protrusion (470) which forms a bridge between the third upright wall of the frame profile (200) and the body of the coupling element (400).

1. A side guide for a screen device for a screen which can be rolled up and unrolled, the side guide comprising a hinge point and:
a screen profile for receiving an edge of the screen;
a frame profile;
a cover profile, comprising a hinge element provided with a protrusion; and
a coupling element which can be coupled to the frame profile and comprises a flexible body provided with an engaging protrusion;
configured such that rotation of the hinge element over the hinge point ensures that the engaging protrus on of the coupling element engages on the protrusion of the hinge element.

2. The side guide according to claim 1, wherein
the frame profile has a rear wall and at least two upright walls which form a space for receiving the screen profile, wherein a first upright wall is provided with a stop for the screen profile and a second upright wall is provided with the hinge point;
the cover profile comprises a stop wall on which the hinge element is arranged at right angles, wherein the hinge element has a hinge side and a coupling side, and the protrusion extends from the coupling side; and
configured such that rotation of the hinge element over the hinge point ensures that the stop wall of the cover profile forms a stop for the screen profile.

3. The side guide according to claim 1, wherein the cover profile comprises a cover plate for at least partial coverage of the coupling element.

4. The side guide according to claim 1, wherein the frame profile comprises a third upright wall which, with the rear wall and the second upright wall, forms a second space for receiving the coupling element.

5. The side guide according to claim 1, wherein the flexible body of the coupling element comprises a foot which can be coupled to the frame profile.

6. The side guide according to claim 1, wherein the coupling element comprises a further protrusion arranged between the coupling element and an upright wall of the frame profile.

7. The side guide according to claim 1, wherein the frame profile consists of at least two frame profile parts which can be coupled together.

8. The side guide according to claim 7, wherein the coupling element comprises a further protrusion arranged between the coupling element and the second upright wall for clamping a frame profile part to another frame profile part.

9. The side guide according to claim 1, wherein the flexible body of the coupling element is made of plastic.

10. The side guide according to claim 1, wherein the side guide is screwless.

11. A method for mounting a side guide according to claim 1, the method comprising:
(a) provision of a frame profile and coupling of a coupling element to the frame profile;
(b) placing of a screen profile;
(c) placing of a cover profile on a hinge point; and
(d) rotation of the cover profile over the hinge point until the coupling element engages on the hinge element.

12. The method according to claim 11, wherein the frame profile consists of at least two frame profile parts, and wherein step (a) comprises:
provision of a first frame profile part;
coupling of the coupling element to the first frame profile part;
placing of a second frame profile part in the first frame profile part; and
coupling of the second frame profile part to the first frame profile part by means of the coupling element.

13. A method for removing a side guide according to claim 1, the method comprising:
(a) provision of a mounted side guide;
(b) rotation of a cover profile over a hinge point; and
(c) removal of the cover profile from the hinge point.

14. A screen device comprising the side guide according to claim 1.

15. The screen device according to claim 14, wherein the screen device comprises at least one of: a roller shutter, an insect screen, a partition, and a sun blind.
